(19) United States
(12) Patent Application Publication
(10) Pub. No.: US 2025/0338362 A1
(43) Pub. Date: Oct. 30, 2025

(54) ADAPTIVE CHARACTERIZATION PROCESS FOR INDUCTION COOKTOP SYSTEM

(71) Applicant: WHIRLPOOL CORPORATION, Benton Harbor, MI (US)

(72) Inventors: Emil Locarni, Verbania (IT); Marco Mattioni, Comabbio (IT)

(21) Appl. No.: 18/648,865

(22) Filed: Apr. 29, 2024

(51) Int. Cl. H05B 6/06; H05B 6/12

(52) U.S. Cl. CPC H05B 6/062; H05B 6/1209

(57) ABSTRACT

A method for adaptive characterization for an inductive cooking appliance may include applying a k-th excitation frequency to a model circuit; analyzing the frequency response of the k-th excitation frequency including determining at least one of a maximum current, maximum power factor, and maximum power of the circuit; determining a frequency limit based on an inverse relationship of the at least one of the maximum current, maximum power factor and maximum power of the circuit; and determining the next excitation frequency based on the frequency limit and a step size in response to the step size being within a threshold.

### TECHNICAL FIELD

Disclosed herein are adaptive characterization process for induction cooktop system.

### BACKGROUND

Induction cooking appliances use induction coils to heat items directly. For instance, the induction coils may directly heat pots and pans through magnetic induction. An electric current is passed through the coil underneath the surface, creating a magnetic current throughout the pot or pan above to produce heat. Thus, as opposed to other types of cooking appliances, the surface of induction cooking appliances stays relatively cool while maintaining a consistent temperature on pots and pans and delivering power with a higher efficiency.

### SUMMARY

A method for adaptive characterization for an inductive cooking appliance may include applying a k-th excitation frequency to a model circuit; analyzing the frequency response of the k-th excitation frequency including determining at least one of a maximum current, maximum power factor, and maximum power of the circuit; determining a frequency limit based on an inverse relationship of the at least one of the maximum current, maximum power factor and maximum power of the circuit; and determining the next excitation frequency based on the frequency limit and a step size in response to the step size being within a threshold.

A method for adaptive characterization for an inductive cooking appliance may include applying a k-th excitation frequency to a model circuit; analyzing the frequency response of the k-th excitation frequency including determining at least one of a maximum current, maximum power factor, and maximum power of the circuit; determining a frequency limit based on an inverse relationship of the at least one of the maximum current, maximum power factor and maximum power of the circuit; and determining the next excitation frequency based on the frequency limit; determining a step size based on the next excitation frequency and the k-th excitation frequency; and applying the next excitation frequency to the model circuit in response to the step size being within a threshold.

A method for adaptive characterization for an inductive cooking appliance may include applying a k-th excitation frequency to a model circuit; analyzing the frequency response of the k-th excitation frequency including determining at least one of a maximum current, maximum power factor, and maximum power of the circuit; determining a frequency limit based on an inverse relationship of the at least one of the maximum current, maximum power factor and maximum power of the circuit; determining the next excitation frequency based on the frequency limit; applying a tunable gain to the next excitation frequency; determining whether a step size based on the next excitation frequency and the k-th excitation frequency is within a threshold; and applying the next excitation frequency to the model circuit in response to the step size being within a threshold.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a side view of an induction cooking system;

FIG. 2 illustrates an example graph of the frequency vs. power of various excitation frequencies;

FIG. 3 illustrates an example RLC equivalent circuit for the first, analysis phase of the process;

FIG. 4 illustrates an example frequency response for the frequency computation where fₖ is the switching frequency at each time instant k;

FIG. 5 illustrates an example distribution of excitation frequencies;

FIG. 6 illustrates an example flow chart for a process for determining whether to terminate the characterization process; and

FIG. 7 illustrates another example flow chart for a characterization process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Cooktops or other induction cooking appliances include induction coils, often referred to as pancake coils due to their structure. When powered, these coils create a magnetic field, which in turn, can be used to heat up a cooking vessel or other cooking item formed of ferromagnetic material placed on the cooktop. The cooking item may be referred to herein as a load. When an alternating current (AC) passes through the winding, the current creates a magnetic field that induces an eddy current into the load, thus heating up the bottom of the load due to the Joule effect. During heating, it can be crucial to identify how the behavior of the load changes as the inverter switching frequency changes. This process is referred to as characterization and consists in the excitation of the inverter in a set of certain frequencies called excitation frequencies and the analysis of the response. Excitation frequencies are actuated one at a time, starting from a higher frequency and moving lower.

Characterization must be done before power delivery and repeated every time the load changes significantly. The less the number of excitation frequencies used, the faster the characterization procedure is, resulting in better user experience.

Normally, during the characterization phase, that electronics components (in particular transistors such as Insulated-gate bipolar transistors (IGBTs), and the coil) are stressed. This is due to the fact that the characterization process ends when a particular physical quantity (e.g., the amount of current flowing in the IGBTs) exceeds an overload threshold. Instead, disclosed herein is a system that by, analyzing the data from the current measurements, predicts when the characterization process should be ended in advance, avoiding component overload.

Traditional characterization includes monitoring electrical quantities such as the active power, current flowing in the IGBTs and coil, and power factor. This approach has two main drawbacks. The first one is that the characterization is stopped after a certain limit is exceeded, causing inevitable electronic components overloads. The second one is related to the frequency step. The choice of this parameter is quite crucial. If the step is too small, a higher precision is achieved but with a higher number of points (i.e., more time required). Instead, if a larger value is selected the process is fast but the precision of the curve may not be enough, especially in the lower frequency range. The characterization procedure may be finished too much in advance, leading to lower performances in the power delivery phase. Moreover, the sensitivity of the curve (i.e., the slope of the P-f curve) is quite different at low and high frequency ranges. The selection of the same frequency step for both ranges could not be the best choice, leading to an excessive precision at high frequencies and a not sufficient one at lower frequencies.

During characterization, the frequencies are actuated for at least one halfwave of the main line (ca. 8-10 ms). Since the number of points is not negligible, the time reserved for characterization is quite relevant and has a direct influence on the cooktop-user interaction. The disclosed system instead is able to distribute the excitation frequencies in a more optimal way, reducing the number of points acquired (i.e., number of halfwaves required) and therefore reducing the time needed for the whole procedure. The disclosed system therefore adapts the frequency step according to the working point. Moreover, the algorithm establishes when the characterization procedure should terminate before an actual limit is reached, therefore avoiding inverter overloads.

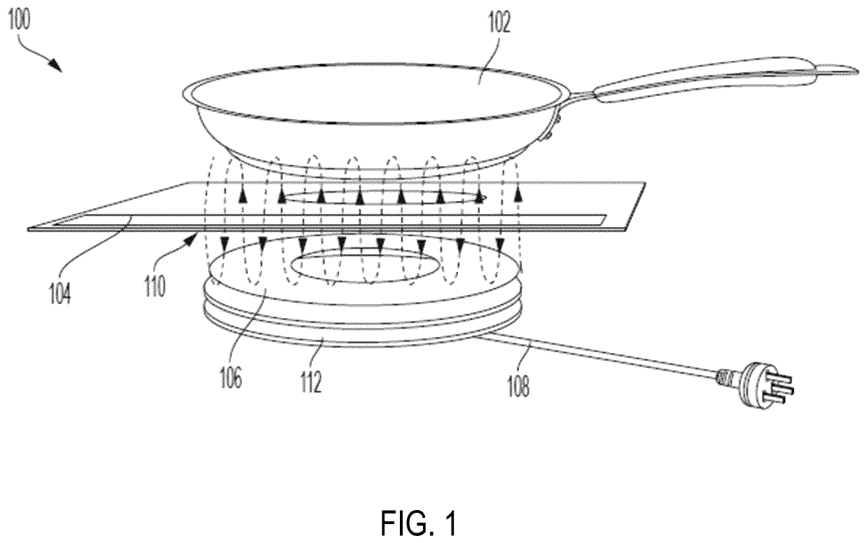

FIG. 1 illustrates a side view of an induction cooking system 100. The system 100 may be an induction cooktop configured to generate an electromagnetic field to rapidly and directly heat a load 102 placed thereon. The load may be any type of cooking vessel or other cooking item configured to conduct and withstand high heat, such as a pot, pan, griddle, etc. In the examples discussed herein, the load is made of metal, and more specifically a metal containing iron, such as a stainless steel cooking item. However, other highly magnetic metals may additionally or alternately be used. The system 100 may include a cooktop surface 104 for receiving the load 102. The cooktop surface 104 may be formed of glass, ceramic, or another high-heat resistant surface.

An induction coil winding 106 is arranged below the cooktop surface 104. The induction coil 106 may be a copper coil or another material suitable for electric flux (such as aluminum or CCA, copper clamped aluminum, or other) configured to receive electrical current from a power source 108. The power source 108 may supply high frequency AC by an electronic board, in a range greater than 18 kHz. The alternating current may generate magnetic flux, creating an electromagnetic field 110 that causes electrons to vibrate within the load bottom 102. The vibrating electrons create heat, thus heating the bottom surface of the load 102. The load 102 may then heat the contents of the load 102 through conductive heat.

The electromagnetic field 110 is converted into thermal energy directly, creating an efficient heating mechanism. Because of the direct conversion, the amount of heat generated may be easily and effectively controlled by controlling the strength of the magnetic field. Further, because the load 102 is heated with a magnetic field, the cooktop surface 104 remains generally cool.

The electromagnetic field 110 may create eddy currents, which are loops of electrical current induced within conductors by a changing magnetic field in the conductor. Eddy currents flow perpendicular to the magnetic field and are generally proportional in magnitude to the magnetic field and the rate of change of flux. The eddy current creates a magnetic field that opposes the change in the magnetic field that created it and causes energy loss and heat.

During use, while the cooktop surface 104 may remain cool, the coil winding 106 may generate heat. The system 100 may include a shield 112 arranged below the coil winding 106 to disperse and prevent the coil winding 106 from becoming too hot. The shield 112 may structurally maintain the coil winding 106 within a cooktop assembly or cabinet. The shield 112 may reduce electromagnetic noise generated by the coil winding 106 and also acts as an electromagnetic barrier configured to block the eddy currents generated by coil winding 106.

As explained above, the load 102 may change and characterization of the load may be required. This is achieved by generating a sequence of frequencies that are actuated for at least one halfwave of the main line. The faster the characterization process is completed, the better the user experience.

The coil winding 106 may be controlled by a controller or processor. The controller may include the machine controller and any additional controllers provided for controlling any of the components of the system 100. Many known types of controllers can be used for the controller. It is contemplated that the controller is a microprocessor-based controller that implements control software and sends/receives one or more electrical signals to/from each of the various working components to implement the control software.

The controller may also include or be coupled to a memory configured to include instructions and databases to carry out the systems and processes disclosed herein. The controller may be programmed to instruct the excitation or switching frequencies and maintain various thresholds and factors in the memory.

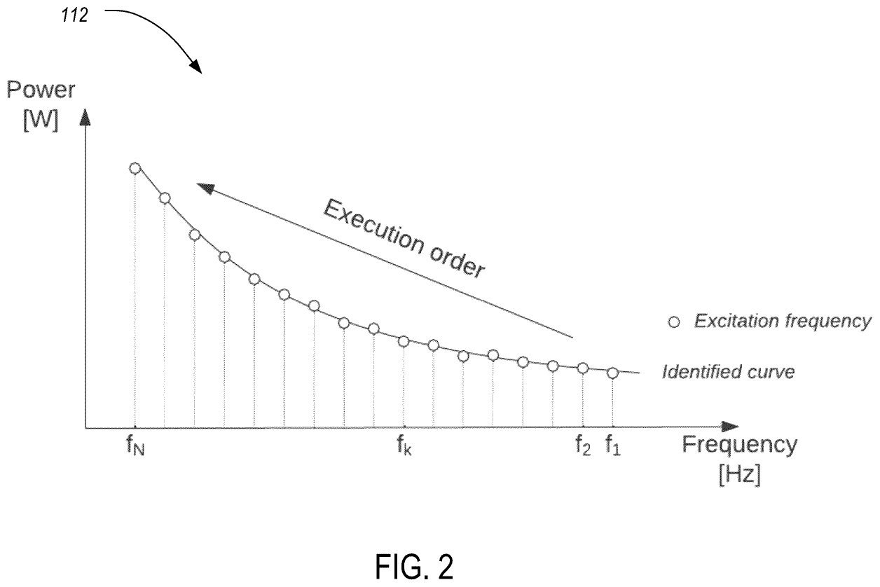

FIG. 2 illustrates an example graph of the frequency vs. power of various excitation frequencies. As explained, characterization is a process for an induction cooktop during which the frequency behavior of the load is determined. This process has to be repeated every time the load varies significantly, for example when the pot is moved or its behavior changes due to thermal effects. In general, the characterization consists in the excitation of the system in a set of N switching frequencies (called excitation frequencies) and the analysis of the corresponding responses. The responses are then fed into an identification algorithm for use for heating the load.

The N excitation frequencies are traditionally equally spaced by a fixed frequency step, as depicted in FIG. 2, where the Power-Frequency curve (in the following P-f) is considered. Each frequency sample is actuated for at least one halfwave of the main line, which corresponds to 8-10 ms (depending on the frequency of the line). The process starts at higher frequencies, in particular at f₁, which is safer for the components because they involve less currents, power, etc. The characterization process ends at f_{N} after a variable number of points N, when a certain limit is reached and is not possible to proceed further without damaging the electronic components.

When the switching frequency is high the hardware components operate generally in a nominal range. Contrariwise, as the frequency is decreased, the various components are generally more overloaded (higher current flow, etc.). Thus, there is an advantage to starting characterization at the higher frequencies and drawing out the excitation at the higher frequencies to avoid excitation at the lower frequencies. Moreover, at higher frequencies, the system is less sensitive, meaning that the curve is quite “flat”. Instead, at lower frequencies, the behavior is more sensitive, slope of the curve is higher.

Thus, this system herein analyzes the behavior of the excitation in a certain i-th excitation frequencies to compute the best next one (i+1th), as well as understands where the characterization has finished.

In general, the system monitors electrical quantities to ensure each do not exceed overload thresholds. These include, active power, current flowing in the IGBTs and coil, and power factor. The characterization is generally broken down into three operations: 1. Analysis of the behavior of the circuit at the k-th excitation frequency; 2. Computation of the frequency limit, i.e. the smaller acceptable frequency that, if exceeded would cause an overload; and 3. Calculation of the next excitation frequency and decision if the process should be continued or terminated.

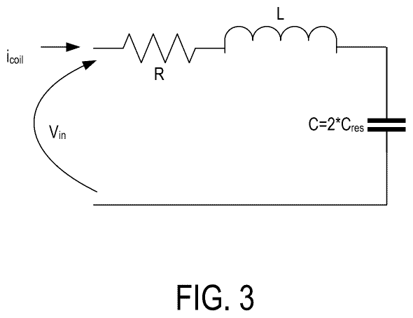

FIG. 3 illustrates an example RLC equivalent circuit 400 for the first, analysis phase of the process. Such circuit is selected because an induction heater is typically modelled as an equivalent RLC circuit, which is easier to be studied with classical circuit theory. Given this model, the resistance is considered linearly dependent on the angular frequency ω=2 πƒ (where f is the switching frequency) as follows:

$$R ( ω ) = {R}_{0} ω$$

Where R is modeled as proportional to switching frequency (common assumption in Half-Bridge induction cooktop modeling). The parameters L, and R₀ are identified from the response analysis, while C is a known parameter and depends on the capacitors used. These parameters are used in the subsequent steps to compute the frequency limit.

The second operation consist in the computation of the frequency limit. The frequency limit is the smallest frequency step that can be reached. Generally, three main quantities are limited: the active power, the power factor and the impedance, which is strictly related to the coil current (e.g., max current).

Analytically, the problem is to compute the minimum frequency ωₘᵢₙ^{Z} to be sure that the current which flows in the circuit is below a certain threshold Iₘₐₓ, which is related to the impedance.

$${ω}_{m i n}^{Z} s . t . I ( ω ) < {I}_{m ax} for any ω > {ω}_{m i n}^{Z}$$

The same logic can be applied to the limitation of power factor and active power, where:

$${ω}_{m i n}^{c os ( ϕ )} s . t . cos ( ϕ ) < {cos ( ϕ )}_{m ax} for any ω > {ω}_{m i n}^{c os ( ϕ )} \\ {ω}_{m i n}^{P} s . t . P ( ω ) < {P}_{m ax} for any ω > {ω}_{m i n}^{P}$$

To find the minimum frequencies ωₘᵢₙ^{Z} which guarantees impedance limitations, the relationship of the impedance in an RLC circuit is depicted as:

$$\vert Z ( ω ) \vert = \sqrt{{( R )}^{2} + {( X )}^{2}} \\ \vert Z ( ω ) \vert = \sqrt{{( {R}_{0} ω )}^{2} + {( ω L - \frac{1}{ω C} )}^{2}}$$

This leads to a second order equation via inverting impedance module above, in the variable x=ω², where Z is the minimum impedance, Z=Zmin=V/Iₘₐₓ (V is the rms voltage applied to the RLC equivalent circuit):

$${x}_{1} = \frac{2 LC + {\overline{Z}}^{2} {C}^{2} + \sqrt{{( - 2 LC - {\overline{Z}}^{2} {C}^{2} )}^{2} - 4 ( {R}_{0}^{2} {C}^{2} + {L}^{2} {C}^{2} )}}{2 ( {R}_{0}^{2} {C}^{2} + {L}^{2} {C}^{2} )} \\ {x}_{2} = \frac{2 LC + {\overline{Z}}^{2} {C}^{2} - \sqrt{{( - 2 LC - {\overline{Z}}^{2} {C}^{2} )}^{2} - 4 ( {R}_{0}^{2} {C}^{2} + {L}^{2} {C}^{2} )}}{2 ( {R}_{0}^{2} {C}^{2} + {L}^{2} {C}^{2} )}$$

For purposes herein, the first solution x₁ (greater one) is relevant, therefore the minimum acceptable switching frequency that guarantee a non-excessive coil current is:

$${ω}_{m i n}^{Z} = \sqrt{{x}_{1}}$$

The procedure is repeated for the power factor, which for an RLC circuit is written as:

$$cos ( ϕ ) = \frac{Re \{ Z \}}{\vert Z \vert} = \frac{{R}_{0} ω}{\sqrt{{( {R}_{0} ω )}^{2} + {( ω L - 1 / ( ω C ) )}^{2}}}$$

This leads to a second order equation in the variable x=ω², where cos(ϕ)=cos(ϕ)ₘₐₓ is the maximum acceptable power factor:

$${x}_{1} = \frac{L {\overline{cos}}^{2} ( ϕ ) + \overline{cos} ( ϕ ) {R}_{0} \sqrt{1 - {\overline{cos}}^{2} ( ϕ )}}{( {\overline{cos}}^{2} ( ϕ ) - 1 ) {R}_{0}^{2} C + {\overline{cos}}^{2} ( ϕ ) {L}^{2} C} \\ {x}_{2} = \frac{L {\overline{cos}}^{2} ( ϕ ) - \overline{cos} ( ϕ ) {R}_{0} \sqrt{1 - {\overline{cos}}^{2} ( ϕ )}}{( {\overline{cos}}^{2} ( ϕ ) - 1 ) {R}_{0}^{2} C + {\overline{cos}}^{2} ( ϕ ) {L}^{2} C}$$

Again, the first solution is relevant, therefore the minimum acceptable switching frequency that guarantee a non-excessive power factor is:

$$ω\_min \_cos ( ϕ ) = \sqrt{X 1}$$

Then, the active power may be written as:

$$P = \frac{{V}^{2}}{{\vert Z \vert}^{2}} Re ( Z ) = {V}^{2} \frac{ω {R}_{0}}{{( {R}_{0} ω )}^{2} + {( ω L - 1 / ( ω C ) )}^{2}}$$

This leads to the following fourth order equation where P=Pₘₐₓ is the maximum acceptable active power):

$$[ ( {R}_{0}^{2} + {L}^{2} ) {C}^{2} ] {\overline{ω}}^{4} - \frac{{C}^{2} {R}_{0} {V}^{2}}{\overline{P}} {\overline{ω}}^{3} - 2 LC {\overline{ω}}^{2} + 1 = 0$$

Which is solved in the unknown ω with standard solutions techniques for the equations of fourth order, rewritten as:

$$a {\overline{ω}}^{4} + b {\overline{ω}}^{3} + c {\overline{ω}}^{2} + d \overline{ω} + e = 0 \\ Where : \\ a = [ ( {R}_{0}^{2} + {L}^{2} ) {C}^{2} ] \\ b = - \frac{{C}^{2} {R}_{0} {V}^{2}}{\overline{P}} {\overline{ω}}^{3} \\ c = - 2 LC {\overline{ω}}^{2} \\ d = 0 \\ e = 1$$

The solutions are:

$${\overline{ω}}_{1 , 2} = - \frac{b}{4 a} - Q \pm \frac{1}{2} \sqrt{- 4 {Q}^{2} - 2 p + \frac{S}{Q}} \\ {\overline{ω}}_{3 , 4} = - \frac{b}{4 a} + Q \pm \frac{1}{2} \sqrt{- 4 {Q}^{2} - 2 p + \frac{S}{Q}} \\ \text{Where:} \\ q = 12 ae - 3 bd + {c}^{2} \\ s = 27 {ad}^{2} - 72 ace + 27 {b}^{2} e - 9 bcd + 2 {c}^{3} \\ \text{With:} \\ Q = \frac{1}{2} \sqrt{- \frac{2}{3} p + \frac{1}{3 a} ( {Δ}_{0} + \frac{q}{{Δ}_{0}} )} \\ {Δ}_{0} = \sqrt[3]{\frac{z + \sqrt{{s}^{2} - 4 {q}^{2}}}{2}} \\ \text{And:} \\ p = \frac{8 ac - 3 {b}^{2}}{8 {a}^{2}} \\ S = \frac{8 {a}^{2} d - 4 abc + {b}^{3}}{8 {a}^{3}}$$

Among the four solutions only the one which has physical meaning (real, positive and the greater one) should be selected, providing the minimum acceptable switching frequency that guarantee a not excessive power ωₘᵢₙ^{P}.

Finally, the results are merged, selecting the maximum (more constraining) threshold among the computed ones:

$${ω}_{m i n} = max ( {ω}_{m i n}^{Z} , {ω}_{m i n}^{co s ( ϕ )} , {ω}_{m i n}^{P} ) \\ {f}_{m i n} = \frac{1}{2 π} {ω}_{m i n}$$

Being sure that, if the system will work at a frequency higher than ƒₘᵢₙ the constraints would be satisfied.

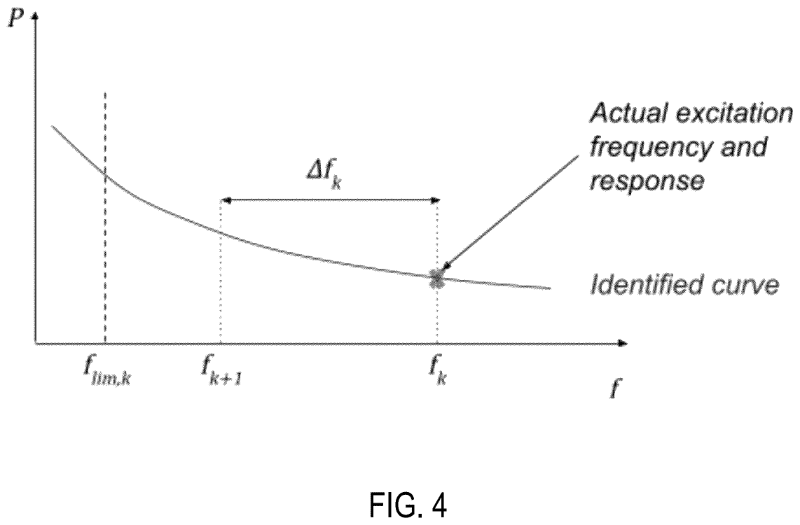

FIG. 4 illustrates an example frequency response for the frequency computation where fₖ is the switching frequency at each time instant k. This provides a visual for the last step in the excitation frequency computation. The frequency step Δƒ is the difference between the excitation frequency fₖ and the next excitation frequency fₖ₊₁. Given the limit computed at time instant k (where the switching frequency fₖ has been actuated), the next excitation frequency fₖ₊₁ can be found:

$${f}_{k + 1} = {f}_{k} - Δ {f}_{k} \\ Δ {f}_{k} = \frac{{f}_{k} - {f}_{l im , k}}{μ}$$

where ƒ_{lim,k} is the frequency limit computed with the measurements obtained exciting the circuit at the switching frequency fₖ and μ is a tunable parameters or gain which defines the behavior of the algorithm according to the following table:

| Value of μ | Behavior | Speed to convergence |
|---|---|---|
| Low | More aggressive | Faster (less points) |
| High | More conservative | Slower (more points) |

For example, the tunable gain may be 2 (e.g., bisection method).

Finally, the step size Δf can be saturated to a maximum one to avoid making excessive frequency k steps at high frequency. The frequency limit F_{lim,k} may be computed with impedance at time k.

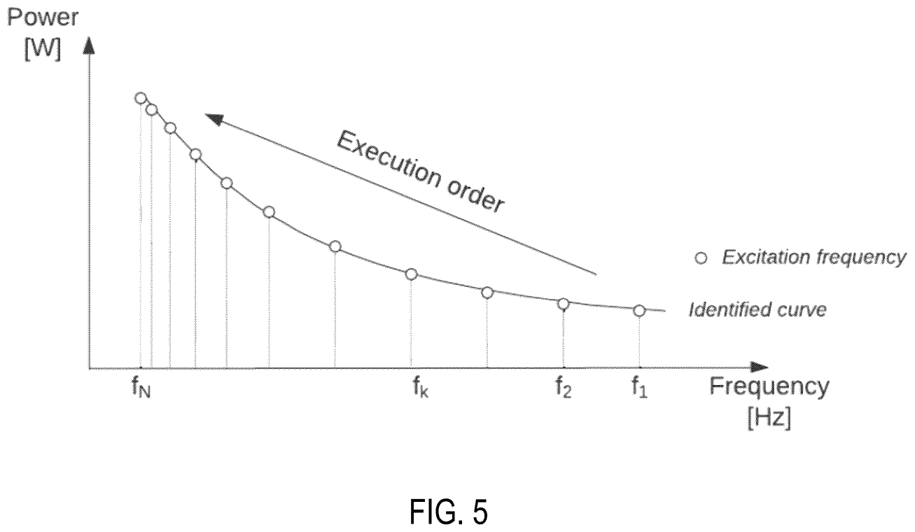

FIG. 5 illustrates an example distribution of excitation frequencies. As illustrated, the distances between the frequency samples decreases as the frequency approaches the limit. This is important because the sensitivity and the precision are enhanced exactly where it is needed, i.e., near the frequency limit (which is near to f_{N}). Instead, at higher frequency the steps are larger, allowing the characterization to converge faster and therefore saving time.

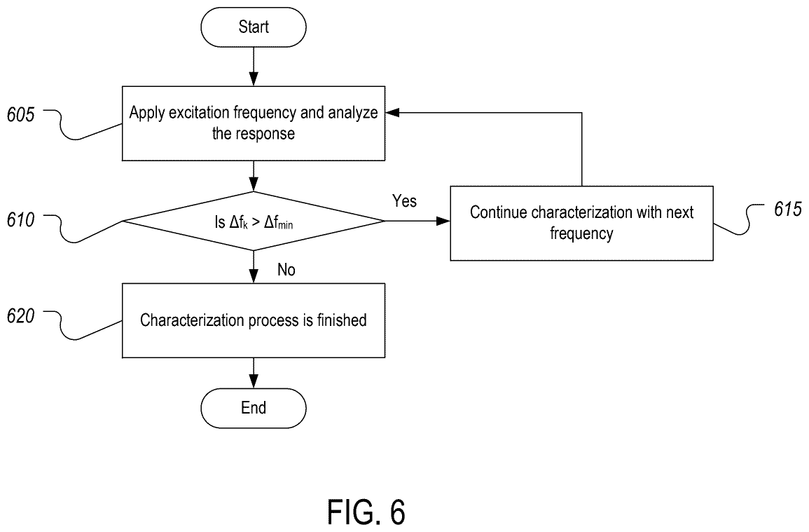

FIG. 6 illustrates an example flow chart for a process 600 for determining whether to terminate the characterization process. In an example, the process 600 may be performed by the controller or processor in the context of the induction cooking system 100. This process 600 outlines the decision to terminate or not terminate the characterization procedure by comparing the value of Δƒₖ with respect to a threshold Δƒₘᵢₙ. If Δƒₖ is sufficiently small, the circuit is thus being actuated quite near to the limits and then the characterization can be stopped.

The process 600 may start at block 605 where an excitation frequency fₖ is applied to the circuit and analyzed via the steps outlined above.

At block 610, the frequency response is compared to the threshold response. If the frequency response is greater than the threshold, the process 600 proceeds to block 620. If not, the process proceeds to block 615.

At block 615, the process 600 continues the characterization process with the next frequency, while at block 620, the characterization process is complete. Such process allows higher frequency steps at the beginning of the processes, allowing the characterization to converge towards the threshold.

Thus, the proposed system is able, from the response analysis, to predict the behavior of the circuit in a certain frequency, calculate precisely the frequency limit and avoid component overloads. Moreover, the proposed logic for the definition of the excitation frequencies is able to distribute them in an optimized way, being faster and increasing the sensitivity in the most critical frequency range and decreasing it in the less critical one.

This process 600 results in a more reactive and responsive behavior of the cooktop (due to the fact that the process is accelerated), leading to a better user experience. In fact, the characterization process most of the time is done when the customer is interacting with the cooktop (selecting the power level or moving the pot for cooking purposes) and therefore it is strictly related to how the user perceives the product.

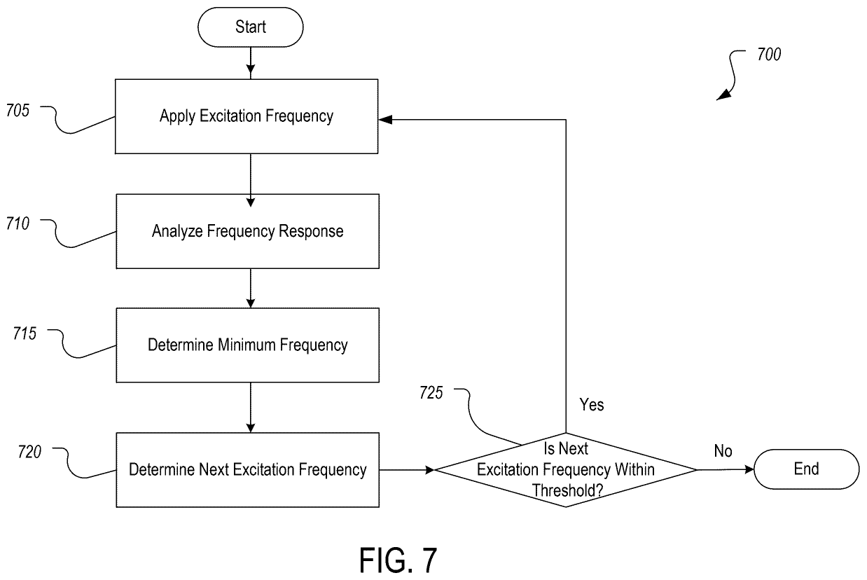

FIG. 7 illustrates another example flow chart for a characterization process 700. As with the process 600, the process 700 may be performed by the controller or processor in the context of the induction cooking system 100. The process 700 may start at block 705 where the excitation frequency fₖ is applied. For example, the process 700 may be initiated responsive to the controller or processer being requested to perform power delivery and/or responsive to detection of a change in the load (e.g., due to differences in the electrical properties of the coil).

At block 710, the frequency response of the excitation frequency fₖ is analyzed. This may include determining the maximum current, maximum power factor and maximum power. As explained above, these factors and relationships may be based on standard RLC circuit theory.

As block 715, a minimum switching frequency or frequency limit ƒ_{lim,k} is determined. This determination is based on an inverse relationship of at least one of the maximum current, maximum power factor and maximum power of the circuit. That is, given the maximum impedance, power factor and active power, what is the minimum switching frequency.

At block 720, next excitation frequency fₖ₊₁ is determined based on the frequency limit ƒ_{lim,k} and a step size Δf. The step size Δf is determined based on difference between the excitation frequency fₖ and the frequency limit ƒ_{lim,k}. A tunable gain μ is applied in the inverse to adjust the ratio to be more or less aggressive based on a desired convergence of the subsequent excitation frequencies, as explained above. The more aggressive, the lower the value of μ and the faster the convergence of the excitation frequency. The more conservative, the higher the value of μ and the slower the convergence.

At block 725, the next excitation frequency fₖ₊₁ is compared to the frequency threshold. The threshold Δƒₘᵢₙ may be a step size that is small enough for convergence. In one example, the threshold may be 100 Hz.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for adaptive characterization for an inductive cooking appliance, comprising:
applying a k-th excitation frequency to a model circuit;
analyzing the frequency response of the k-th excitation frequency including determining at least one of a maximum current, maximum power factor, and maximum power of the circuit;
determining a frequency limit based on an inverse relationship of the at least one of the maximum current, maximum power factor and maximum power of the circuit; and
determining the next excitation frequency based on the frequency limit and a step size in response to the step size being within a threshold.

2. The method of claim 1, further comprising applying a tunable gain to next excitation frequency.

3. The method of claim 2, wherein the tunable gain value is set based on a desired convergence of the next excitation frequency.

4. The method of claim 1, further comprising determining a minimum acceptable switching frequency for each of the maximum current, maximum power factor and maximum power of the circuit.

5. The method of claim 4, wherein the determining the frequency limit includes selecting a highest one of each of the minimum acceptable switching frequencies for the maximum current, maximum power factor and maximum power of the circuit.

6. The method of claim 4, wherein the minimum acceptable switching frequency for the maximum current is based on a minimum impedance of the model circuit.

7. The method of claim 4, wherein the minimum acceptable switching frequency for the power factor is based at least in part on a resistance linearly dependent to the switching frequency.

8. The method of claim 4, wherein the minimum acceptable switching frequency for the power is based at least in part on a linearly dependent resistance of the model circuit.

9. A method for adaptive characterization for an inductive cooking appliance, comprising:
applying a k-th excitation frequency to a model circuit;
analyzing the frequency response of the k-th excitation frequency including determining at least one of a maximum current, maximum power factor, and maximum power of the circuit;
determining a frequency limit based on an inverse relationship of the at least one of the maximum current, maximum power factor and maximum power of the circuit; and
determining the next excitation frequency based on the frequency limit;
determining a step size based on the next excitation frequency and the k-th excitation frequency; and
applying the next excitation frequency to the model circuit in response to the step size being within a threshold.

10. The method of claim 9, further comprising applying a tunable gain to next excitation frequency.

11. The method of claim 10, wherein the tunable gain value is set based on a desired convergence of the next excitation frequency.

12. The method of claim 9, further comprising determining a minimum acceptable switching frequency for each of the maximum current, maximum power factor and maximum power of the circuit.

13. The method of claim 12, wherein the determining the frequency limit includes selecting a highest one of each of the minimum acceptable switching frequencies for the maximum current, maximum power factor and maximum power of the circuit.

14. The method of claim 12, wherein the minimum acceptable switching frequency for the maximum current is based on a minimum impedance of the model circuit.

15. The method of claim 12, wherein the minimum acceptable switching frequency for the power factor is based at least in part on a resistance linearly dependent to the switching frequency.

16. The method of claim 12, wherein the minimum acceptable switching frequency for the power is based at least in part on a linearly dependent resistance of the model circuit.

17. A method for adaptive characterization for an inductive cooking appliance, comprising:
applying a k-th excitation frequency to a model circuit;
analyzing the frequency response of the k-th excitation frequency including determining at least one of a maximum current, maximum power factor, and maximum power of the circuit;
determining a frequency limit based on an inverse relationship of the at least one of the maximum current, maximum power factor and maximum power of the circuit;
determining the next excitation frequency based on the frequency limit;
applying a tunable gain to the next excitation frequency;
determining whether a step size based on the next excitation frequency and the k-th excitation frequency is within a threshold; and
applying the next excitation frequency to the model circuit in response to the step size being within a threshold.

18. The method of claim 17, wherein the tunable gain value is set based on a desired convergence of the next excitation frequency.

19. The method of claim 17, further comprising determining a minimum acceptable switching frequency for each of the maximum current, maximum power factor and maximum power of the circuit.

20. The method of claim 19, wherein the determining the frequency limit includes selecting a highest one of each of the minimum acceptable switching frequencies for the maximum current, maximum power factor and maximum power of the circuit.
